(19) United States
(12) Patent Application Publication
(10) Pub. No.: US 2024/0325243 A1
(43) Pub. Date: Oct. 3, 2024

(54) BODY MASSAGING AND WASHING APPARATUS

(71) Applicant: SAMWELL TESTING INC., NEW TAIPEI CITY (TW)

(72) Inventors: SHAU-SAN WU, NEW TAIPEI CITY (TW); HUI-CHEN YEN, NEW TAIPEI CITY (TW); JIN-LIANG CHEN, NEW TAIPEI CITY (TW)

(21) Appl. No.: 18/127,159

(22) Filed: Mar. 28, 2023

(51) Int. Cl. A61H 33/14

(52) U.S. Cl. CPC A61H 33/14; A61H 2033/0016; A61H 2033/141; A61H 2230/04

(57) ABSTRACT

A body massaging and washing apparatus, which is a harmonized intelligent active oxygen generator (low concentration ozone) that adjusts the concentrations according to the conditions of users, and can be used at any time; it performs physiological detection before and after use, so as to carry out non-wearable physiological detection for the user, which includes heart rate autonomic nerve balance and thermal imaging to display the balance state of the body, and deploys fragrance according to personal physical fitness testing, and with non-contact Schumann wave resonance, strengthens deep cleansing and body relaxation, becoming an integrated cleaning and epidemic prevention physiology detect relieve stress and relax and personalize physiological physique detection and deploy experience fragrance technology, which can provide users with humanized anti-epidemic care, and allow caregivers and doctors to identify users' physiological conditions.

### BACKGROUND OF THE INVENTION

### Field of the Invention

The present invention relates to a bathing device, in particular to a body massaging and washing apparatus that can provide cleaning, physiological measurement and fragrance.

### Description of the Related Art

At present, most of the examples of automatic bathing devices in foreign countries are traditional bathing machines, most of which still require manual operation, and few of them can provide functions of sterilization, physiological detection and pressure relief. In response to the life style of co-existing with the epidemic in the post-epidemic era and the increase in nursing labor costs, there is an urgent need to have an automatic bathing device for a humanized care, cleaning and epidemic prevention strategy, especially for automatic monitoring and high-risk environments, to implement body cleaning care that takes care of the needs and care process. The automatic bathing device of the present invention not only has the function of reducing both epidemic prevention and nursing labor costs and risks to meet the needs of scientific and technological precision cleaning and nursing, but also integrates cleaning and epidemic prevention, physiological detection, stress relief and relaxation experience and personalization physiological physique detection and deployment of fragrance technology provides users with humanized anti-epidemic care, and allows caregivers and doctors to identify users' physiological conditions.

Regarding the bathing device of the published patent antecedents, those having functions related to the present invention are listed as follows:
(1) cleaning and sterilization function:
U.S. Pat. No. 6,463,600: Automatic Shower and Tub Cleaner
CN108542294A: A Swing Type Fully Automatic Intelligent Shower Bathtub
TA000782800_AN: Ozone biological oxidation high density water bath device
   (2) Massage and pressure relief function:
CN111920322B: Intelligent Voice Interaction Automatic Bathing Machine
KR101967285B1: Automatic shower apparatus
CN206189920U: Integrated Automatic Shower Room
CN202778761U: Automatic Shower Cleaning Massager
   (3) Physiological data detection and control functions:
CN212698661U: Fully Automatic Smart Shower System Based On Multisensor Data Fusion
CN213248736U: A 5G Voice-activated Smart Shower Device)
   (4)Automation and matching suitability selection function:
   CN106354185B: An Automatic Control System and Method For An Intelligent Shower Room
KR102107333B1: Automatic Shower
KR101606994B1: Automatic Shower
WO2014019475A1: Fully automatic bathing machine and bathing machine scrubbing machine
US 2017/0350103 A1: Intelligent shower system and method for automatically updating shower formula
CN105616091B: A Kind Of Automatic Bath Bed With Mechanical Device
CN109758013A: An Automatic Bathing Device
U.S. Pat. No. 5,829,072A: Automatic shower control

### SUMMARY OF THE INVENTION

In view of the above, the present invention is objected to provide an automatic bathing apparatus, which has the following functions: active oxygen cleans and epidemics prevents, with the harmonious type intelligent active oxygen manufacturing machine (low concentration ozone) in response to the regulation and concentration control of the target to be used with the system; carry out physiological detection before and after use to carry out non-wearable physiological detection for users, which includes heart rate autonomic nerve balance and thermal images to display the body's balance state, deploy and experience fragrance according to personal physiological physique detection, and match with non-contact Schumann wave resonance strengthens deep cleaning and body relaxation. It not only can automatically bathe most parts of the human body with the least amount of water and manpower at one time, but also has multiple functions of showering, bathing, sterilization, bath conditions detection and stress relief.

A preferably embodiment of the body massaging and washing apparatus of the present invention includes a hollow chamber, which is provided with mechanisms such as water spray devices and seat, physiological detection and Schumann resonance pressure relief, and the shape of hollow channel can be rectangular, square, cylindrical, ellipse, etc.

According to said embodiment of the present invention, said hollow chamber has a seat, and a slide rail is arranged on the seat bracket to be connected with the hollow cabin. The seat slide rail allows the user to move the seat to a position which is easier to move into, and then slides into the chamber of the apparatus with the seat rail.)

According to said embodiment of the present invention, a physiological detection part is arranged in the waterproof area of the outer edge of the hollow cabin, with an elastic pad above it to withstand the back of the hand, and a detection metal electrode below, which can facilitate the user to place the palm of the hand onto a non-wearable way to detect physiological signals such as heart rate/ECG/autonomic nerves.

According to said embodiment of the present invention, a thermal image detection device part is arranged in the waterproof area of the outer edge of the hollow chamber, which can conveniently detect the temperature zone on the body image (relative temperature distribution and inflammation portion of limb).

According to said embodiment of the present invention, a Schumann resonance device is arranged on the base of the hollow chamber, which can facilitate users to detect physiological signal of heart rate/ECG/multiple autonomic nerves with non-wearable waterproof electrodes and sensors.

While a preferred second embodiment of the body massaging and washing apparatus of the present invention includes a hollow chamber, an electronically controlled automatic device, which can possess the function of active oxygen sterilization, and utilizes an ozone water generating device to measure and regulate the ozone concentration, which can provide low ozone concentration controller: human body oxygen sterilization and cleaning in human mode (ozone concentration is 0.05 ppm˜0.1 ppm) and hollow chamber cleaning in unmanned mode (ozone concentration<0.12 ppm).

According to said embodiment of the present invention, it also includes an electronically controlled automatic device, which can be matched with a spray atomization nozzle to produce a variety of fragrance bubbles of ultra-nano active oxygen, and the warm water mixed with low-concentration ozone can be borrowed together, so as to clean the human body by spraying into the chamber.

According to said embodiment of the present invention, the said electronically controlled automatic device can provide drying for the body (occupied mode) and chamber (chamber cleaning mode).

According to another embodiment of the present invention, the electronically controlled automatic device can detect object perception and voice warning for spraying and sterilizing when someone is/is not in the chamber.

According to said embodiment of the present invention, the electronically controlled automatic device can detect the temperature and/or humidity in the chamber.

According to another preferred embodiment of the present invention, the electronically controlled automatic device can be automatically set according to the process and display the status on the computer display.

The said electronic control system of the above manned mode and unmanned mode include the steps of:
(1) Manned mode: detection of physiological pre-test (<5 minutes); preparation of matching aroma and low concentration ozone; ozone fragrance micro-foam spray cleaning (at least 10 minutes); clear water rinse (at least 10 minutes, can be divided segment); drying (at least 10 minutes); at the same time, perform stress relief and resonance relaxation (10 minutes to 30 minutes).
(2) Unmanned mode: start the cleaning chamber (unmanned detection), low-concentration ozone preparation (<0.12 ppm); ozone fragrance micro-foam spray cleaning (at least 10 minutes); clear water rinse (at least 10 minutes, can section); dry the chamber (at least 10 minutes).

According to a further embodiment of the present invention, the electronically controlled automatic device can be connected to a host computer and a control system to integrate user interface functions, including ozone concentration measurement and control to manufacture low-concentration ozone and automatically spray according to set parameters sterilization, physiological signal detection, bathing process and control, data transmission and recording can use by touch to set parameters and control.

According to said embodiment of the present invention, the electronically controlled automatic device can be connected to the physiological detection induction, Schumann wave resonance feedback and aroma matching control module, and display physiological parameters on the panel to perform physiological data calculation program calculation and display the results, or automatically accumulate and archive the system data and upload it to the area network data collection and subsequent processing applications.

The above and other objects, features and advantages of the present invention can be fully understood according to the following detailed description based on the accompanying drawings.

### BRIEF DESCRIPTION OF THE DRAWINGS

FIG. 1 is an overall schematic view of an embodiment of the body massaging and washing apparatus of the present invention.

FIG. 2 is a schematic diagram of another embodiment of the body massaging and washing apparatus of the present invention.

FIG. 3 is a schematic diagram of the electric control system of the bath chamber of an embodiment of the body massaging and washing apparatus of the present invention.

FIG. 4 is a system block diagram of the electric control system of the bath chamber and the display of the host computer in an embodiment of the body massaging and washing apparatus of the present invention.

FIG. 5 is a bathing flowchart of an embodiment of the body massaging and washing apparatus of the present invention.

FIG. 6 is a flow chart of the cleaning chamber of an embodiment of the body massaging and washing apparatus of the present invention.

Remarks: In the drawings, components or devices or systems with the same name, which are represented by different symbols/numbers in different drawings, can be the same object.

### DETAILED DESCRIPTION OF PREFERRED EMBODIMENT

### Example 1

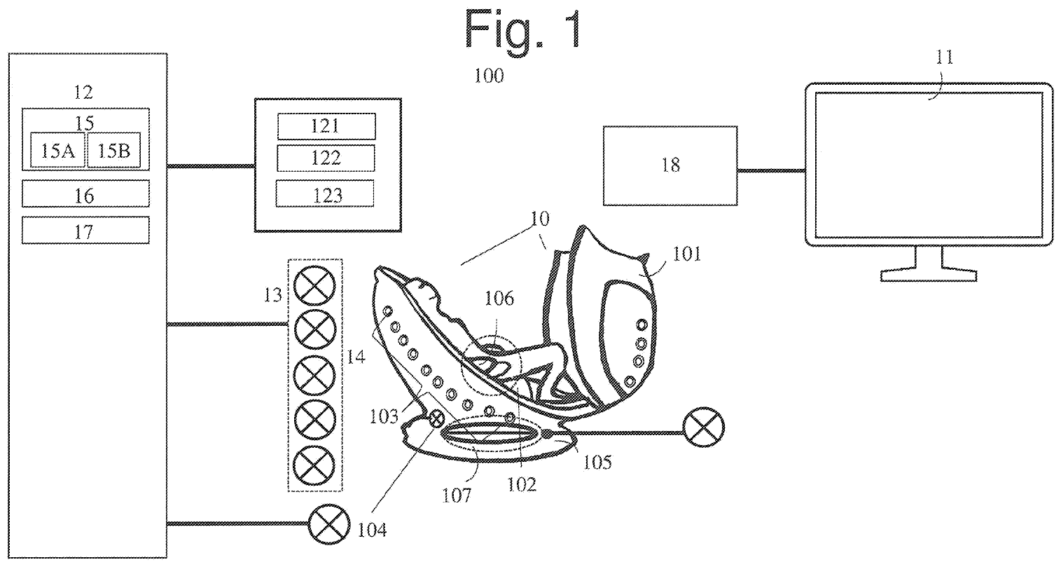

Please refer to FIG. 1, which represents an embodiment of the body massaging and washing apparatus of the present invention. The body massaging and washing apparatus 100 of the present invention mainly includes a bathing chamber 10, a host computer system 11, an electric control system 12, a pipeline system 13, a bath liquid spraying part 14, a warm air control system part 15, a manned/unmanned warning device part 16, a temperature and humidity detection system part 17, and a physiological detection system part 18.

The above-mentioned bath chamber 10 is a cavity for covering the human body, which can be in various shapes, and the chamber part has a waterproof door 101 that can be opened, and the bather's head is exposed. A seat 102 is arranged inside the chamber, and a liquid pipeline system 103 and a warm air pipeline system 104 are arranged around the chamber, and a drainage hole 105 is arranged at the bottom, forming a closed space by tempered glass or other plastic materials. In the waterproof space, there is a waterproof base 106 next to the seat 102 for detecting physiological signals, and a Schumann resonance pressure relief device 107 is provided at the bottom of the entire chamber.

The electric control system 12 can be used to control the circuit control and induction detection of various bathing modes, and it includes an ozone water generation part 121, an ozone concentration measurement system part 122 and an ozone concentration control system part 123, to provide Low ozone concentration control, and to provide manned mode (ozone concentration is 0.05 ppm˜0.1 ppm) for human body oxygen sterilization and cleaning and unmanned mode for cleaning the chamber (ozone concentration is less than 0.12 ppm); ozone water can also be suitable for other kinds sanitation water.

The electronic control system 12 can be matched with the bath liquid sprayer 14 to generate a variety of fragrance bubbles of ultra-micron nano active oxygen. The electric control system 12 can also provide a warm air control unit 15 to dry the body (manned mode 15A) and chamber (unmanned mode 15B).

The electronic control system 12 may also include an manned/unmanned warning device part 16 for detecting object perception and voice warning for spraying and sterilizing when the chamber is manned or unmanned.

The electronic control system 2 may further include a temperature and humidity detection unit 17 to automatically detect the temperature and humidity in the chamber 10. And the physiological detection system part 18, which is connected to the host computer 11.

### Example 2

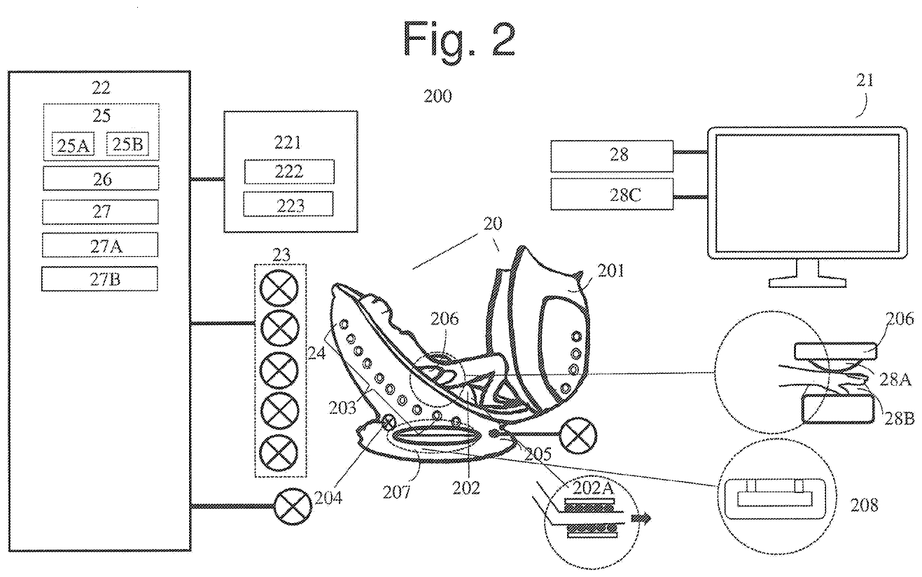

Please refer to FIG. 2, which shows another embodiment of the body massaging and washing apparatus of the present invention. The body massaging and washing apparatus 200 of this embodiment of the present invention mainly includes a bath chamber 20, a host computer system 21, an electric control system 22, a pipeline system 23, a bath liquid spraying part 24, and a warm air control system part 25, can dry the body (manned mode 25A) and chamber (clean chamber mode 25B), manned/unmanned warning part 26, a temperature and humidity detection system part 27, and a physiological detection system 28.

The bath chamber 20 is a cavity for covering the human body, which can be in various shapes, and the chamber has a waterproof door 201 that can be opened and exposes the bather's head. A seat 202 is provided inside the chamber, a liquid pipeline system 203 and a warm air pipeline system 204 are provided around the chamber, and a drainage hole 205 is provided at the bottom, and a waterproof base 206 for detecting physiological signals, a Schumann resonance pressure relief device 207 is provided at the bottom of the entire chamber, which is sealed into a waterproof space by tempered glass or other materials. The electric control system is connected with a manned/unmanned warning device part 26, a temperature and humidity detection system part 27, a bathing machine start button 27A, and a bathing machine stop button 27B.

The bath chamber 20 is provided with a seat 202 inside, and is connected to the bath chamber 20 by means of a slide rail 202A installed on the seat bracket. The seat slide rail 202A allows the user to move to Easier to move into the seat position, and then slide into the bath chamber 20 with the seat slide rail 202A.

The pipeline system 203 of the bath chamber 20 includes a bath liquid spraying device part 24, a warm air control system part 25 and a drain hole 205 at the bottom. Where in, the bath liquid spraying device part 24 includes the prepared low-concentration ozone water and aroma foam and injects it with warm water and cold water; the warm air control system part 25 can introduce warm air for drying the human body and the chamber; the cleaned sewage Then it is discharged from the drain hole 205.

The bath chamber 20 has a physiological detection system part 28 installed in the waterproof area of the outer edge of the chamber. There is an elastic pad 28A above the outer edge of the chamber to withstand the back of the bather's hand, and the bottom is for detection. The metal electrode 28B is convenient for users to put their palms in to detect physiological signals such as heart rate/ECG/autonomic nerves in a non-wearable manner.

The electric control system 22 of the bath chamber 20 also includes a presence/absence warning device part 26, a temperature and humidity detection system part 27 that can detect the temperature and humidity of the chamber, and a bath machine start button 27A, a bathing machine stop button 27B to test the remote start or stop the automatic flow of the automatic bathing device, wherein the presence/absence warning device part 26 can also detect object perception and voice warning voice warning of spraying sterilization when there is manned/unmanned in the chamber.

In the bath chamber 20, a part of a thermal image detection device 28C is installed in the waterproof area of the chamber outer edge, which can easily detect the temperature zone on the body image (relative temperature distribution and inflammation of the limb circulation).

In the bath chamber 20, a Schumann resonance pressure relief device 207 is installed in the chamber base 208, which can facilitate the user to detect physiological conditions such as heart rate/ECG/multiple autonomic nerves in a non-wearable and waterproof manner. Signal and guide Schumann resonance to relieve stress.

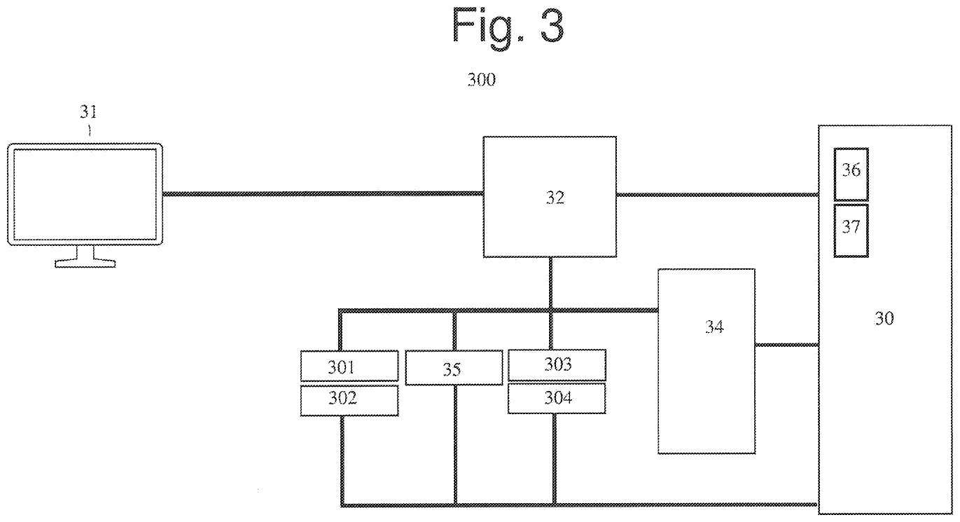

Please refer to FIG. 3 representing an embodiment of the computer host system and the electric control system of the body massaging and washing apparatus of the present invention. The computer host system 31 and the electric control system 32 of the automatic bathing device 300 of the present invention include an ozone water generation system part 303, a low concentration ozone water detection and regulation system part 304, a bath liquid spraying device part 34, and a warm air control system part 35. Presence/unmanned warning system part 36, temperature and humidity detection system part 37.

The electric control system 32 of the automatic bathing device 300, wherein the ozone water generation system part 303 and the ozone water detection and control system part 304 can possess the low-concentration ozone water of active oxygen sterilization function, which can provide human body active oxygen sterilization Manned mode for cleaning (ozone concentration is 0.05 ppm˜0.1 ppm) and unmanned mode for cleaning the chamber (ozone concentration is less than 0.12 ppm).

The electronic control system 32 of the body massaging and washing apparatus includes a cold water system part 301 and a warm water generation temperature control system part 302, wherein the bath liquid spraying device 34 is matched with a variety of fragrance bubbles of ultra-micronano active oxygen, which can be mixed The warm water of low-concentration ozone water goes into the chamber together to clean the human body.

In the electric control system 32 of the body massaging and washing apparatus, the warm air control system part 35 can provide drying of the body (manned mode) and chamber (unmanned mode).

In the electronic control system 32 of the body massaging and washing apparatus, the manned/unmanned warning system part 36 can detect object perception and voice warnings for spraying and sterilizing when there are manned/unmanned in the chamber.

In the electronic control system 32 of the body massaging and washing apparatus, the temperature and humidity detection system part 37 can detect the temperature and humidity in the bath chamber 21.

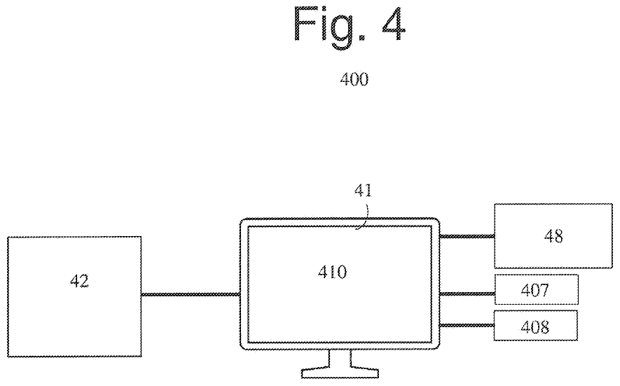

Please refer to FIG. 4, which shows the main display of another embodiment of the body massaging and washing apparatus of the present invention. According to the electronic control system 42 of the body massaging and washing apparatus 400 of the present invention, it can be connected with the computer host system 41, and can display the user interface function 410, including physiological data, temperature and humidity data in the chamber, water temperature data, ozone water concentration data and control manufacturing. Low-concentration ozone is automatically sprayed and sterilized according to the set parameters, physiological signal detection and bathing process and control, data transmission and recording can use the control to set parameters and control.

The above-mentioned host computer system 41 includes a physiological measurement detection system part 48 which is connected to a Schumann resonance relief device 407 and the bath fluid spray comparison device 408 to generate the best mode and display physiological parameters perform physiological data calculation program calculations on the panel, and display the test results. The system data is automatically accumulated and archived, and uploaded to the local area network for data collection and subsequent processing applications.

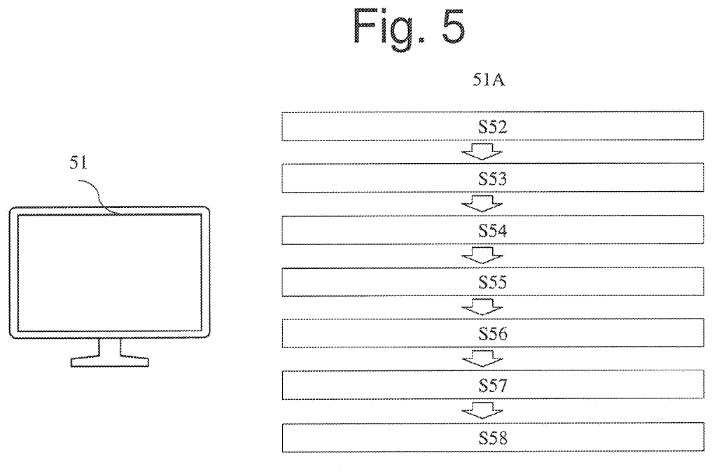

FIG. 5 is a bath flow chart of a preferred embodiment of the present invention.

Please refer to FIG. 5, wherein the host computer 51 can automatically set and display the state according to the flow process and display the state 51A of “manned mode”, and automatically execute the following bathing process:
(1) Display and detect physiological pretest state S52 (<5 minutes).
(2) Display low-concentration ozone preparation state S53.
(3)Display the ozone fragrance micro-bubble spraying state S54 (at least 10 minutes).
(4) Display the state of flushing with water S55 (at least 10 minutes, which can be segmented).
(5) Display the drying state S56 (at least 10 minutes).
(6) Display the relaxation state S57 of stress relief resonance (10 minutes to 30 minutes).
(7) Show bathing end S58.

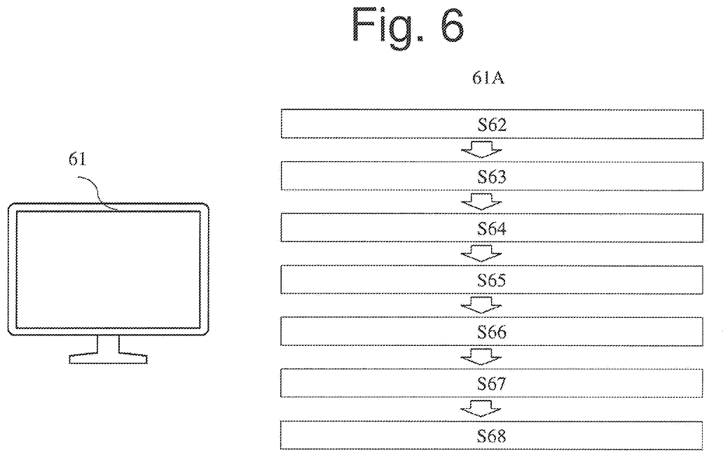

FIG. 6 is a cleaning flowchart of a preferred embodiment of the present invention.

Please refer to FIG. 6, wherein the host computer 61 can be automatically set according to the process, and the display state is displayed in the “unmanned mode” state 61A, and the following chamber cleaning process is automatically performed:
(1) Display the unmanned detection state S62.
(2) Display the start-up cleaning chamber S63.
(3) display low concentration ozone preparation state S64 (concentration is less than 0.12 ppm).
(4) Show ozone fragrance micro-bubble spraying state

S65 (at least 10 minutes).
(5) Display the state of flushing with water S66 (at least 10 minutes, which can be segmented).
(6) Display the drying state S67 (at least 10 minutes).
(7) Display the end of cleaning chamber S68.

Although the preferred embodiments of the present invention have been described above in conjunction with the accompanying drawings, the present invention is not limited to the specific embodiments described above. The above-mentioned specific embodiments are only illustrative, not limiting, and can be specified in many forms without departing from the purpose of the present invention and the scope of protection of the claims.

1. A body massaging and washing apparatus, comprising: a bathing chamber for covering the human body, an electric control system with a circuit control part and an induction detection part for controlling the apparatus, a pipeline system, a bath liquid spraying device part, a host computer, a liquid pipeline, and a warm air pipeline system; wherein the bottom of the bath chamber is provided with a drain hole, which is sealed by tempered glass or other materials to form a waterproof space, and there is a temperature detection system, a single detection system part for detecting a physiological signal, an image detection part for detecting a thermal image, and a Schumann resonance pressure relief device.

2. The body massaging and washing apparatus as claimed in claim 1, which further includes: an ozone water generation system part, a low-concentration ozone water detection and control system part, a cold water system part, a warm water generation and temperature control system part, and a variety models of fragrance bath liquid control system department, a temperature and air control system part, a manned/unmanned warning system part, and a temperature and humidity detection system part.

3. The body massaging and washing apparatus as claimed in claim 2, wherein the ozone water generation system part can provide the manned mode (concentration of 0.05 ppm-0.1 ppm) for human body oxygen sterilization and cleaning and the unmanned mode (concentration less than 0.12 ppm) for cleaning the chamber.

4. The body massaging and washing apparatus as claimed in claim 1, wherein the electronic control system can regulate the spraying device of the bath liquid to produce a variety of fragrance bubbles with ultra-micronano active oxygen; and provide temperature control to dry the body (manned mode) and the chamber (unmanned mode).

5. The body massaging and washing apparatus as claimed in claim 1, wherein the electronic control system also includes a manned/unmanned warning device to detect object perception and voice warning voice of spraying sterilization when the chamber is in manned/unmanned condition; and a temperature and humidity detection system to automatically detect the temperature and humidity in the chamber.

6. The body massaging and washing apparatus as claimed in claim 1, wherein the seat inside the chamber is connected to the bath chamber by installing the slide rail on the seat bracket, and the seat slide rail allows the user to move first from the seat that is easier to move in, then slide into the chamber of the apparatus with the seat slide rail.

7. The body massaging and washing apparatus as claimed in claim 1, wherein the piping system of the bathing chamber includes the bath liquid spraying device part and the warm air piping system part.

8. The body massaging and washing apparatus as claimed in claim 1, wherein the bath liquid spraying device part of the bathing chamber can be used for injection of prepared low-concentration ozone water, fragrance foam, warm water and cold water; the air duct system can introduce the warm air that dries the human body and the chamber; the cleaned sewage is discharged through the drain hole.

9. The body massaging and washing apparatus as claimed in claim 1, wherein the physiological detection system is installed in the waterproof area on the outer edge of the chamber, there is an elastic pad on the top of the chamber to withstand the back of the hand, and the detection metal electrode is on the bottom, it is convenient for users to put their palms in to detect physiological signals such as heart rate/ECG/autonomic nerves in a non-wearable manner.

10. The body massaging and washing apparatus as claimed in claim 1, wherein the part of the thermal image detection device is installed in the waterproof area on the outer edge of the chamber, which can easily detect the temperature zone on the body image (relative to the circulation of the limbs) temperature distribution and inflamed sites).

11. The body massaging and washing apparatus as claimed in claim 1, wherein said Schumann resonance pressure relief device is installed on the chamber base, which can facilitate the user to detect heart rate/ECG/multiple physiological signals such as autonomic nerves guide Schumann resonance to relieve stress.

12. The body massaging and washing apparatus as claimed in claim 1, wherein said electronically controlled automatic device can regulate a variety of fragrance bath liquid control systems, and can be used with the bath liquid spraying device to produce ultra-nano oxygen-activating various fragrance bubbles, the warm water mixed with low-concentration ozone water is sprayed into the chamber through the shower to clean the human body.

13. The body massaging and washing apparatus as claimed in claim 1, wherein said electronically controlled automatic device can be connected to the host computer system to integrate user interface functions, including ozone concentration measurement and control to produce low-concentration ozone, according to set parameters, perform automatic spraying and sterilization, physiological signal detection, bathing process and control, and the data transmission and recording can use touch panel to set parameters and control, and can be connected to physiological detection sensor to perform Schumann wave resonance feedback and fragrance matching control module; and
display physiological parameters to perform physiological data calculation program calculations on the panel and display experience results, system data is automatically accumulated and archived and uploaded to the area network for data collection and subsequent processing applications.

14. The body massaging and washing apparatus as claimed in claim 1, wherein the said electronically controlled automatic device mentioned therein can be connected to the computer host system to automatically set and display the status according to the process, display “manned mode” and automatically execute the following bathing process:
(1) Detection of physiological pre-test (<5 minutes)
(2) Matching aroma and preparation of low concentration ozone
(3) Ozone aroma micro-foam spray cleaning (at least 10 minutes)
(4) Rinse with water (at least 10 minutes, can be segmented)
(5) Drying (at least 10 minutes)
(6) Simultaneously perform stress relief and resonance relaxation (10 minutes to 30 minutes).
(7) The bath is over.

15. The body massaging and washing apparatus as claimed in claim 1, wherein said the electronically controlled automatic device can be connected to the computer host system to automatically set and display the status according to the process. The computer displays “unmanned mode” and automatically executes the following Chamber cleaning process:
(1) Determination of unmanned detection
(2) Start cleaning chamber
(3) Preparation of low concentration ozone (<0.12 ppm)
(4) Ozone fragrance micro-foam spray cleaning (at least 10 minutes)
(5) Rinse with water (at least 10 minutes, can be segmented)
(6) Dry (at least 10 minutes)
(7) The chamber cleaning is finished.
